(19) United States
(12) Patent Application Publication
(10) Pub. No.: US 2017/0012718 A1
(43) Pub. Date: Jan. 12, 2017

(54) DEVICE AND METHOD FOR DETECTING AND MEASURING ALIEN CROSSTALK IN GREATER THAN 1000BASE-T OPERATIONS

(71) Applicant: BROADCOM CORPORATION, Irvine, CA (US)

(72) Inventors: Kishore KOTA, Aliso Viejo, CA (US); Kadir DINC, Irvine, CA (US)

(73) Assignee: BROADCOM CORPORATION, Irvine, CA (US)

(21) Appl. No.: 14/853,461

(22) Filed: Sep. 14, 2015

Related U.S. Application Data
(60) Provisional application No. 62/205,605, filed on Aug. 14, 2015.
(60) Provisional application No. 62/191,209, filed on Jul. 10, 2015.

(51) Int. Cl. H04B 17/318

(52) U.S. Cl. CPC H04B 17/318

(57) ABSTRACT

A device includes circuitry configured to transmit a first test signal to another device via one or more communication links. The device receives a second test signal transmitted from the another device via the one or more communication links. The circuitry is configured to determine a signal-to-noise ratio (SNR) at the device and the another device. Data rates are determined for the one or more communication links based on the SNR at the device and the another device.

### CROSS-REFERENCE TO RELATED APPLICATIONS

The present application claims the benefit of the earlier filing date of U.S. provisional application 62/191,209 having common inventorship with the present application and filed in the U.S. Patent and Trademark Office on Jul. 10, 2015, the entire contents of which being incorporated herein by reference. The present application also claims the benefit of the earlier filing date of U.S. provisional application 62/205,605 having common inventorship with the present application and filed in the U.S. Patent and Trademark Office on Aug. 14, 2015, the entire contents of which being incorporated herein by reference.

### BACKGROUND

Technical Field

The present disclosure is directed to unshielded, twisted pair (UTP) cabling that used for high speed Ethernet links between 1 Gbps and 10 Gbps.

Description of the Related Art

The IEEE standard for 1000BASE-T was developed to operate on up to 100 m of Cat5e cabling. This standard was very successful, resulting in a large worldwide installed base of Cat5e cabling. The 10GBASE-T standard was developed to operate on up to 100 m of Cat6a cabling. Lately, there has been considerable interest in an intermediate speed that can operate on the installed Cat5e cabling because of the expense involved in upgrading to Cat6a cables for 10 Gbps operation.

Differences between Cat6a UTP cabling and Cat5e cabling include differences in operating frequency and alien crosstalk parameter differences. With respect to the operating frequency differences, the parameters of the Cat6a cabling are qualified by the cabling manufacturers and installers to a frequency of 500 MHz, and Cat5e cabling is qualified up to 100 MHz. For frequencies below 100 MHz, there are no significant differences in the cabling parameters for Cat5e and Cat6a cables, except for alien crosstalk parameters. The higher frequency parameters of Cat6a cables are extrapolations of the lower frequency parameters. With respect to the alien crosstalk parameter differences, Cat6a cables are designed and qualified to pass stringent alien crosstalk specifications (e.g., ANEXT and AACR-F). Cat5e cabling does not have any defined alien crosstalk specifications.

To achieve higher speed operations on Cat5e cable installations, combatting alien crosstalk poses one of the more difficult challenges. The measurement of alien crosstalk with standalone cable qualification tools is very cumbersome, slow, and impractical. It is a task that neither cabling vendors nor the installers are willing to tackle for existing cabling. Cable testers were developed by manufacturers, such as FLUKE, to support 10GBASE-T standard.

These testers can in principle be modified to support 2.5 Gbps and 5 Gbps requirements. However, these testers (such as the Fluke DTX Cable Analyzer) can only allow testing an entire cable installation by testing a single victim and a single aggressor at a time because they are limited to a single signal source. As an example, the measurement of all the alien crosstalk into one end of a victim cable surrounded by six aggressors takes 19 different setups and 19 measurements. These setups use various combinations of connecting a local measurement unit, a remote measurement unit and various terminations to the victim and aggressor cables under test. A full measurement of every end of every cable in a big bundle is impractical using these tools. In order to reduce the number of required measurements in large bundles, these tools include recommendations to only measure the 6 worst victims within a bundle and test only the 6 worst aggressors for each victim. However, figuring out the worst victims and aggressors within a large bundle of cables requires experience and judgment and is therefore prone to errors.

Another issue with using existing cable measurements tools is that both ends of all the victim and aggressor cables have to be physically accessed to connect to the test equipment and terminators for the measurements. It is typically possible to access one end of all cables easily within a wiring closet. However, the other end can be in remote locations which are difficult to access, which makes the alien crosstalk measurements even more challenging and impractical.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary illustration of a communication system, according to certain embodiments;

FIG. 2 is an exemplary illustration of a communication system, according to certain embodiments;

FIG. 3 is an exemplary flowchart of a test mode process, according to certain embodiments;

FIG. 4 is an exemplary schematic diagram of a test signal, according to certain embodiments;

FIG. 5 is an exemplary power spectral density (PSD) graph of the test signals, according to certain embodiments;

FIG. 6 illustrates an exemplary info-field, according to certain embodiments; and

FIG. 7 illustrates a non-limiting example of device circuitry, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “approximate,” “about,” and similar terms generally refer to ranges that include the identified value within a margin of 20%, 10%, or 5%, and any values therebetween.

Aspects of this disclosure are directed to an device and method for measuring, qualifying, and provisioning 2.5 Gbps and 5 Gbps speed service on exiting Cat 5e cable installations. To implement a standard for 2.5 Gbps, 5 Gbps, and up to 10 Gbps operations on Cat 5e cable installations, crosstalk noise and signal strength can be measured for communication links connecting one or more devices to ensure that the cable installations can achieve predetermined data rates and performance results.

In an exemplary embodiment, a device includes circuitry configured to transmit a first test signal to another device via one or more communication links. The device receives a second test signal transmitted from the another device via the one or more communication links. The circuitry is configured to determine a signal-to-noise ratio (SNR) at the device and the another device. Data rates are determined for the one or more communication links based on the SNR at the device and the another device.

In another exemplary embodiment, a method includes transmitting a first test signal from a device to a another device via one or more communication links; receiving a second test signal transmitted from the another device via the one or more communication links; determining a signal-to-noise ratio (SNR) at the device and the another device; and determining data rates for the one or more communication links based on the SNR at the device and the another device.

In another exemplary embodiment, a device includes circuitry configured to identify one or more aggressor signals on one or more cables of a Cat5e cable installation, measure an effect of the one or more aggressor signals on noise present in one or more victim signals, and determine a maximum data rate for the one or more cables to achieve predetermined noise and signal strength criteria.

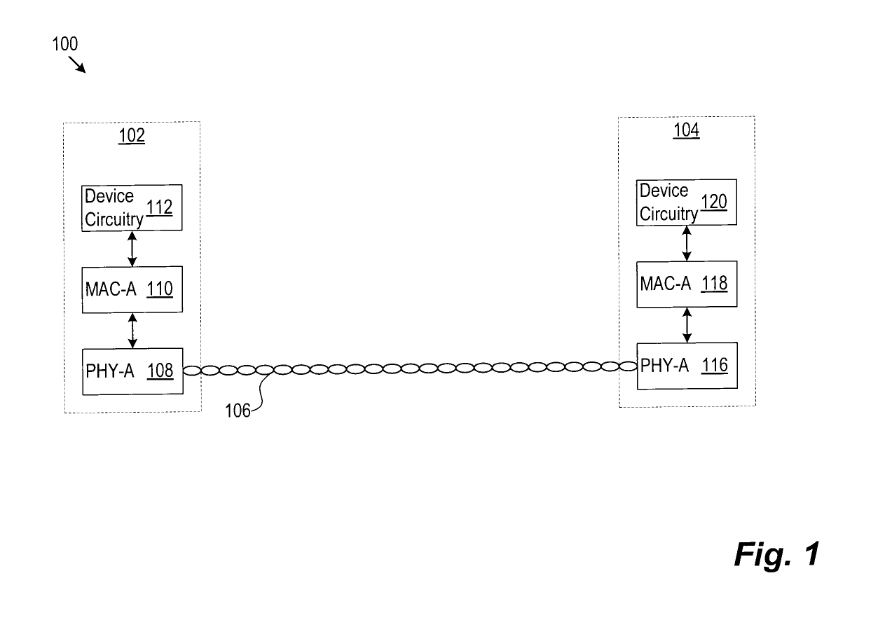

FIG. 1 shows an example communication system 100 in which two link partners, a first device 102 and a second device 104, communicate over a communication link 106. There may be any number of link partners and the link partners may take virtually any form, including as just a few examples: switches, bridges, hubs, servers, client, wireless access point, routers, peripheral devices (e.g., video cameras, voice-over-IP phones, or printers), tablet, laptop, or desktop computers, or any other communication device. The link partners may communicate according to virtually any communications protocol, including any particular variation of Ethernet, IEEE 802.3, including IEEE 802.bz and other variations.

FIG. 1 shows an exemplary implementation of the first device 102, including components of a communication stack. A physical layer (PHY) 108 is part of a transceiver that connects the first device 102 to the communication link 106. The PHY 108 may be a wireline, optical, or wireless interface. Accordingly, as examples, communication link 106 may be implemented as twisted pair cable, backplanes, fiber optic cables, or any other media. In one particular implementation described below, the communication link 106 is a Cat5e cable, and the link partners take turns transmitting and receiving over the communication link 106. The communication link 106 can operate according to one or more communication standards, such as 10GBASE-T, 1000BASE-T, or any other cable standard, which determines communication speed and other parameters, such as operating frequency and alien crosstalk specifications.

The first device 102 also includes media access control (MAC) circuitry 110 that accepts data from the device circuitry 112 for transmission over the communication link 106. The MAC 110 also receives data for delivery to the device circuitry 112 after reception over the communication link 106. The device circuitry 112 may represent any data source or data sink, including hardware, software (e.g., application programs), or a combination of both.

Details regarding the device circuitry 112 are discussed further herein. The second device 104 may also include a transceiver PHY 116, MAC circuitry 118, and device circuitry 120 that have functionality corresponding to the PHY 108, MAC circuitry 110, and device circuitry 112 of the first device 102. According to certain embodiments, the first device 102 and the second device 104 can include more than one PHY 108 and 116.

In one implementation, the first device 102 is a switch that is connected to at least one of the second device 104, which may be a wireless access point, via unshielded cable pairs, such as Cat5e cable. In addition, the capabilities of the first device 102 and second device 104 may vary. For example, the devices 102, 104 may be configured to be able to communicate according to one or more different communication standards, which, among other aspects, determine link speed. The capabilities may also include full or half duplex communication capabilities.

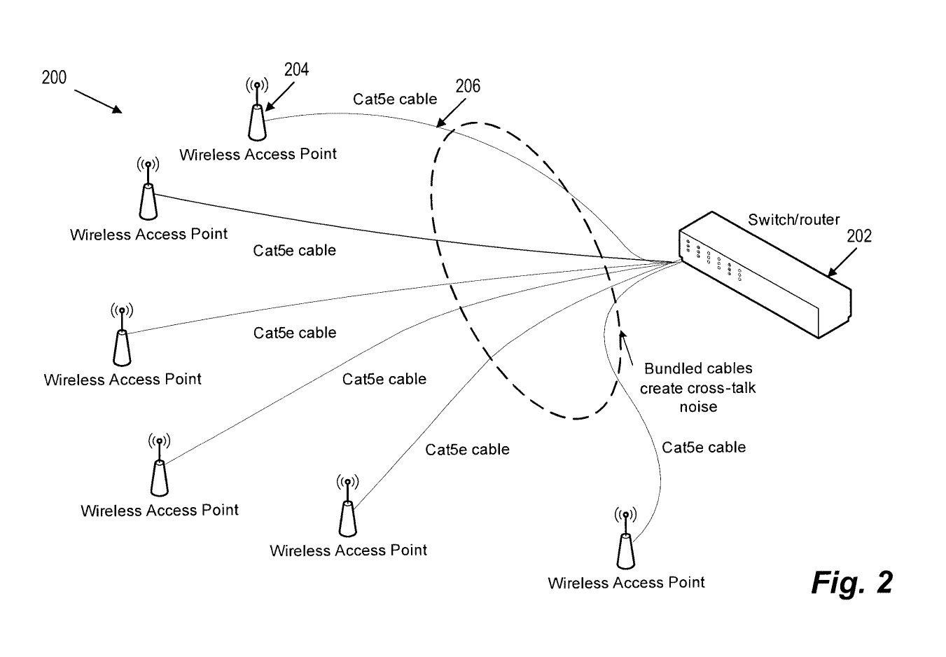

FIG. 2 is an exemplary illustration of a communication system 200, according to certain embodiments. The communication system 200 is an exemplary implementation of the communication system 100 and includes a switch (router) 202 connected to one or more remote access points 204 via communication links that include bundled cables 206. In one implementation, the cables 206 are Cat5e cables. The bundled cables 206 experience cross-coupling, which generates unwanted alien crosstalk noise that can reduce cable reach, data rates, and the like.

According to an embodiment of the present disclosure, a test mode is built into PHYs of the switch 202 and the remote access points 204 to ease the measurement, qualification and provisioning of higher data rates, such as 2.5 Gbps, 5 Gbps, and 10 Gbps, on existing cable installations. In some implementations, cable installations for the examples described herein use a “star” configuration where the switch 202 is an Ethernet switch in a centralized location (a wiring closet) that is connected to remote access points 204, which are distributed across a predetermined area, such as a large building, campus, and the like. The cables 206 from the switch 202 in the wiring closet to the remote access points 104 at remote locations may be bundled for some portion of the installation, which may cause alien crosstalk to couple from each cable into other cables within the same bundle. According to one implementation, the remote access points 204 are wireless access points. Once the switch 202 and the remote access points 204 have been connected using PHYs which support the test mode, a full test of the cabling installation can be initiated from the switch 202. According to certain embodiments, the test mode can be implemented during system installation before the cable system 100 is put into service.

The test mode initiated at the switch 202 can simultaneously place all the selected ports of the switch into the test mode. The switch ports can also include a mechanism to communicate with the PHYs in the access points 204 to place the remote access points 204 into this test mode remotely. The test mode itself includes simultaneously transmitting a broadband signal on all selected ports from both ends of all the cables and measuring both the signal and an amount of coupling from other cables as a function of frequency. The signal and coupling measurements provide information to determine the speeds that can be supported on all the cables that have been tested via the processes described further herein. The measurement results can be transmitted by the remote access points 204 back to the switch 202 to be retrieved via execution of software instructions by processing circuitry of the switch 202 for further analysis and provisioning before exiting the test mode at the switch 202 and the remote access points 204.

The communication between the switch 202 and the remote access points 204 to enter/exit test mode and to return the measurement results can be at a predetermined test mode data rate that is compatible with the type of cabling under all conditions. The test mode data rate ensures that predetermined cable performance criteria are met and may be lower than data rates that are achievable on the cables 206. For example, the predetermined cable performance criteria used to determine the test mode data rate can include cable reach, signal-to-noise ratio, and the like.

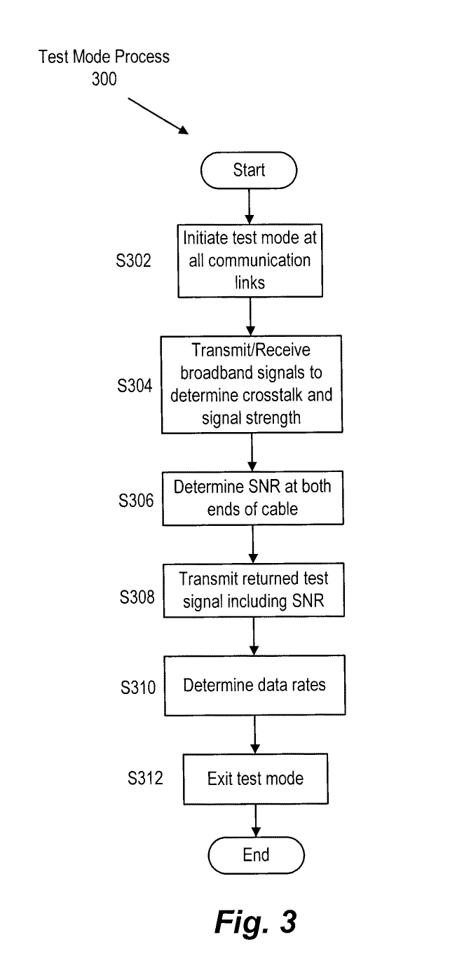

FIG. 3 is an exemplary flowchart of a test mode process 300 for the communication system 200, according to certain embodiments. In some implementations, the switch 202 functions as a controller for the test mode, but in other implementations, another overall controller can be used. In some implementations, one or more of the remote access points 204 can function as the controller for the test mode and the processing circuitry of the remote access points 204 can implement the processes described herein. The processing circuitry of the switch 202 can execute one or more software processes, which can provide a user interface to select ports under test, initiate the test, gather results from the ports, process the measurements, and provide a report of the measurements and achievable speeds on the switch ports. According to certain embodiments, the processing circuitry of the switch 202 is able to determine the crosstalk noise on existing cable installations that have already been installed over a predetermined area. In another embodiment, the processing circuitry of the remote access points 204 can also be configured to perform the software processes described herein.

In one implementation, the switch 202 may include four ports that are connected to four remote access points 204 by cables 206. The processing circuitry of the switch 202 can measure the cross-talk noise that is generated from the coupling of the cables 206. In some embodiments, a cable on which the crosstalk noise is measured is referred to as a victim, and the cables causing the crosstalk noise are referred to as the aggressors. By implementing the test mode process 300 described herein, the processing circuitry of the switch 202 is able to identify one or more aggressor signals on the one or more cables 206 and measure an effect of the one or more aggressor signals on the noise present in one or more victim signals. In addition, the processing circuitry of the switch 202 is able to determine the crosstalk noise for cables having undefined crosstalk noise specifications, such as Cat5e cables.

According to certain embodiments, the measurement of the crosstalk noise can be made dynamically during startup of the switch 202 outside of the test mode; however, there can be no guarantee that all of the aggressors are present at the time of startup. As a result, multiple link downs can occur until all of the PHYs in the switch 202 and the remote access points 204 link up at a speed that can accommodate the crosstalk within the cable bundle. The ability of the crosstalk measurement to be performed during startup of the switch 202 is dependent upon whether link downs or variable speeds are accepted on the cable installation. The test most process 300 described herein can be applied to cable installations where a predetermined data rate can be guaranteed and link downs to downshift to a lower data rate may not be accepted.

At step S302, the processing circuitry of the switch 202 initiates at test mode for the communication links connected to the switch 202. In one implementation, the test mode can be initiated at the PHY for the one or more communication ports of the switch 202 via a test mode capability bit in one of the registers. The test mode capability bit can be exchanged between the switch 202 and the remote access points 204 just as speed capabilities are exchanged between devices in an auto-negotiation sequence. When the test mode is initiated, the PHY in the switch 202 communicates with the remote PHY in the remote access points 204 to place the remote PHY into the test mode. In one implementation, the remote PHYs have the ability to detect a test mode initiation signal from the PHYs in the switch 202 and follow a predetermined test mode protocol to enter the test mode. The coordination between the switch PHYs and the remote PHYs to activate the test mode in the remote PHYs can be a variant of a standard Ethernet auto-negotiation process where the test mode capability bit is exchanged so that the remote PHYs enter the test mode rather than performing a standard startup procedure.

For example, one or more of the IEEE user-defined registers on the PHY can be allocated to the test mode capability bit. If it is determined that a device, such as the remote access point 204 and/or the switch 202 does not have the test mode capability bit set, it is assumed that the device is not capable of implementing the test mode, and the test mode process 300 is terminated. In some implementations, another register can be allocated to a test mode expiration time, which can be exchanged between the switch 202 and the remote access points 204 during auto-negotiation. For example, the processing circuitry of the switch 202 can determine a test mode expiration time, which is a maximum amount of time in which the test mode process 300 is executed before the switch and remote access points 204 exit the test mode. The test mode expiration time can be set to be equal to the auto-negotiation time and can also be decreased or increased based on operational specifications of the communication system, user specifications, and the like. The processing circuitry writes the test mode expiration time to a test mode expiration bit at one of the registers of the PHY and is exchanged between the switch 202 and the remote access points 204 during the auto-negotiation.

When the test mode is initiated, the switch 202 and the remote access points 204 also exchange data rate capability bits to advertise one or more hardware capability data rates, which are data rates at which the devices are capable of operating. The data rate capability bits are indicative of the hardware capabilities of the switch 202 and/or remote access points 204. For example, the data rate capability bits can also be allocated to registers at device ports that indicate whether the devices are capable of communicating at data rates such as 100 Mbps, 1 Gbps, 2.5 Gbps, 5 Gbps, 10 GBps, and/or any other possible data rate. The data rate capability bits can also include an additional override bit that indicates whether the data rate capability bits have been overwritten by the data rates indicated in one or more current operational data rate bits. As will be discussed further herein, the current operational data rate bits include data rates that can be achieved by the devices based on crosstalk noise and other noise in the signals.

According to certain embodiments, the processing circuitry of the switch 202 initiates the test mode when the switch 202 has completed a startup sequence. In addition, the processing circuitry may initiate the test mode when an additional communication link, such as a Cat5e cable, is connected to one or the communication ports of the switch 202. The test mode can also be manually initiated at a user interface on the switch 202.

At step S304, once the test mode has been activated at the PHYs in the switch 202 and the remote access points 204, the switch 202 and the remote access points 204 transmit broadband test signals on all selected ports to the devices at the opposite ends of the cables 206. In one implementation, the PHYs in the switch 202 and the remote access points 204 are configured for full duplex so that the devices can simultaneously transmit unique pseudo random bit sequences (PRBSs) to the other PHYs in the communication system 200 and receive test signals from the devices at the opposite ends of the cables 206. In one implementation, the broadband test signals are constructed as 2-level pulse amplitude modulation (PAM) 10GBASE-T training mode signals that use a PRBS. In addition, in one implementation, the PHYs in the switch 202 and the remote access points 204 perform one or more steps of a 10GBASE-T startup sequence to transmit and/or receive the broadband test signals to and/or from other PHYs to lock to an opposite end signal and acquire the PRBS.

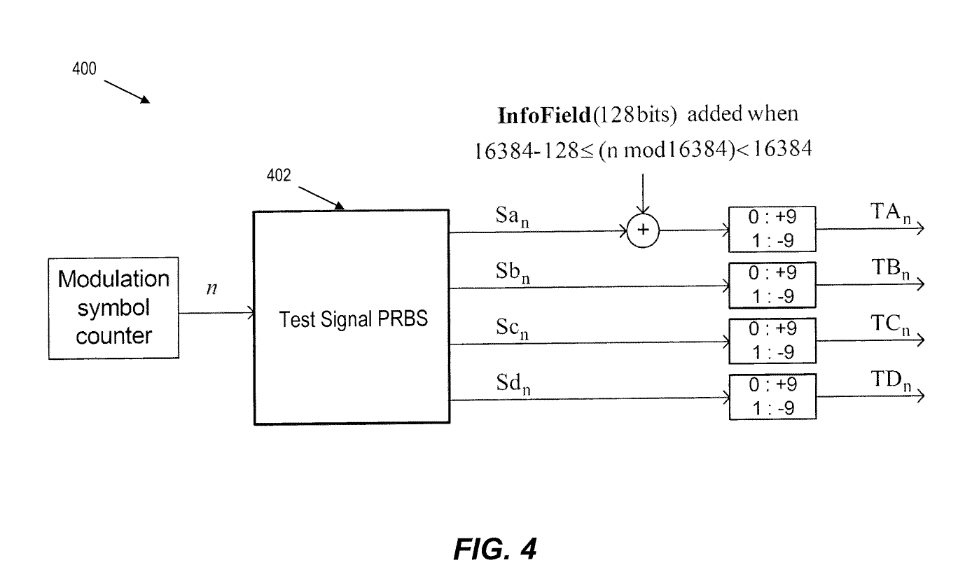

FIG. 4 is an exemplary schematic diagram of a test signal 400, according to certain embodiments. The test signal 400 is an exemplary implementation of a PAM2 10GBASE-T training signal from the IEEE 802.3an standard where the unique PRBS 402 associated with the switch 202 and/or the remote access points 204 is modulated onto the broadband test signals. The test signal 400 is mapped to a 4D symbol (TAₙ, TBₙ, TCₙ, TDₙ) via scramblers Saₙ, Sbₙ, Scₙ, and Sdₙ. The test signal 400 also includes an info-field with additional data such as signal characteristics of the broadband test signal as well as an observed signal-to-noise ratio (SNR) at one end of the cables 206. The signal characteristics can include power, bandwidth, frequency, and the like. Details regarding the info-field and cable SNR are discussed further herein.

Referring back to FIG. 3, at step S306, the processing circuitry of the devices at both ends of the cables 206 determine an amount of crosstalk noise based on the received test signals along with a corresponding SNR at both ends of the cables 206. According to certain embodiments, when the PHYs of the switch 202 and/or remote access points 204 receive the broadband test signals transmitted from the opposite end of the cables 206, the processing circuitry of the devices can determine an amount of crosstalk noise present on both ends of the cables 206 based on the PRBS associated with the test signals. For example, the remote access points 204 can determine an amount of crosstalk noise present at a remote access point end of a corresponding cable by using the PRBS associated with the switch 202 to separate a noise portion from an a signal portion of the broadband test signal. In addition, the processing circuitry of the switch 202 and/or remote access points 204 can determine that any portion of the broadband test signal received by the PHY not associated with the PRBS sequence is crosstalk noise.

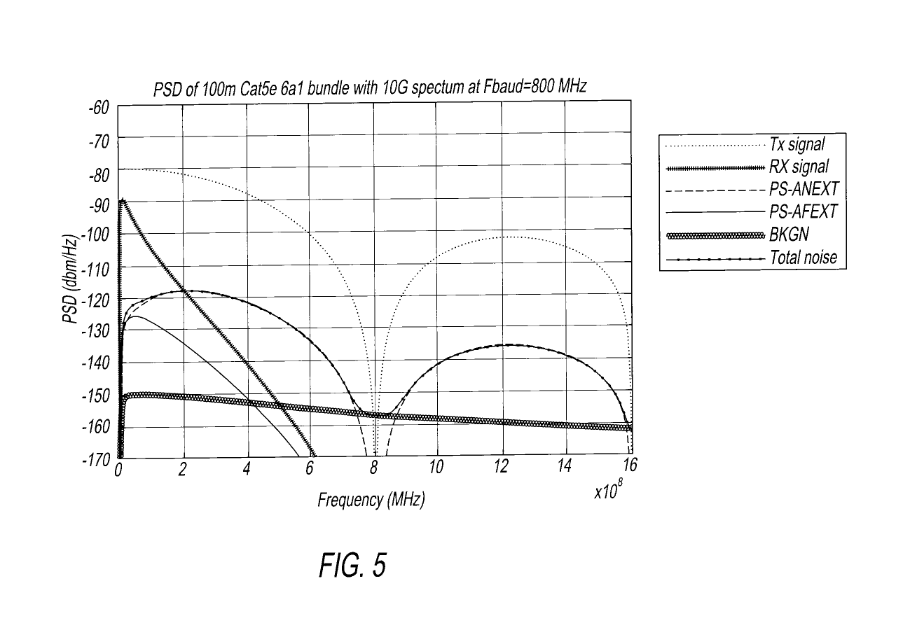

FIG. 5 is an exemplary power spectral density (PSD) graph of the test signals, according to certain embodiments. In one implementation, the broadband test signal, TX signal, transmitted by the switch 202 and/or remote access points 204 includes a 10 Gbps spectrum with a baud rate of 800 MHz so that SNRs for all data rates up to 10 Gbps can be measured for the cables 206, including 1 Gbps, 2.5 Gbps, and 5 Gbps. If the switch 202 and/or remote access points 204 do not support wider test bandwidths, test signals with smaller bandwidths associated with lower data rates, such as 2.5 Gpbs or 5 Gbps, can also be used. When test signals having wider bandwidths are transmitted, the crosstalk noise increases, which can produce more accurate SNR determinations.

The received signal (RX signal) represents the PSD of the test signal received at the PHY of the switch 202 and/or remote access point 204 that has been transmitted across a length of Cat5e cable. In one implementation, the cable length is equal to 100 meters (m), which results in attenuation of a 0.5 V RMS TX signal to a 60-70 mV RMS RX signal. The RX signal can be equalized in the PHY based on the TX signal characteristics transmitted in the info-field of the pseudo-random test signal in order to estimate channel insertion losses and recover the bits from the TX signal. For example, the processing circuitry of the switch 202 can estimate channel response by comparing the power of the RX signal to the power of the TX signal.

The graph shown by FIG. 5 also includes noise curves that include crosstalk noise curves (PS-AFEXT and PS-ANEXT) as well as a background noise (BKGN) curve and a total noise curve. For example, the total noise is the sum of the crosstalk noise curves (PS-AFEXT and PS-ANEXT) and the background noise. Because the AFEXT and ANEXT crosstalk noise are not deterministic, the crosstalk noise may not be able to be separated from the total noise, and the crosstalk noise determination also includes the total noise. In other implementations, the amount of crosstalk noise can be determined based on background noise estimations. The PHY of the switch 202 and/or remote access points 204 can determine the total noise of the received signal based on a difference between an equalized received signal and the TX signal, which is known based on the unique PRBS and the signal characteristics from the info-field of the test signal.

According to certain embodiments, the processing circuitry of the switch 202 and/or remote access points 204 calculate SNRs for each end of the cables 206 based on the RX signal and the total noise signal. For example, the SNR at one end of the cable can be calculated by dividing an integral of the RX signal curve by an integral of the total noise curve. In another implementation, the SNR can also be estimated by dividing a fast Fourier transform (FFT) of the RX signal curve at a predetermined frequency by a FFT of the total noise curve at the predetermined frequency. Because the cables 206 may be more tightly bundled at one end, the crosstalk noise may be more prominent at one end of the cables than at the other end of the cables, which may result in a lower SNR at an end of the cables 206 where the cable bundling is tighter. For example, the SNR at one end of the cable may be 35 dB, and the SNR the opposite end of the cable that is more tightly bundled may be equal to 26 dB. The PHYs of the remote access points 204 send reply signals to the switch 202 that include SNR information, and the processing circuitry of the switch 202 can determine the achievable data rates for the communication links based on the calculated SNRs at the switch 202 and the remote access points 204.

Referring back to FIG. 3, at step S308, the PHYs of the switch 202 and/or the remote access points 204 return reply signals having unique PRBSs to the PHYs of the devices at the opposite end of the cable, which include the SNR calculated at step S306. In one implementation, the reply signal includes an info-field indicating the SNR, total noise, received signal power, and the like. The switch 202 uses signal strength and noise data from the remote access point PHYs determine the amount of noise and the signal power on each of the cables 206 as a function of frequencies of interest. In one implementation, a procedure for returning of the noise and signal data to the PHYs of the switch 202 corresponds to a Tomlinson-Harashima Pre-coded (THP) coefficient exchange procedure in the 10GBASE-T startup, but other faster procedures can also be used.

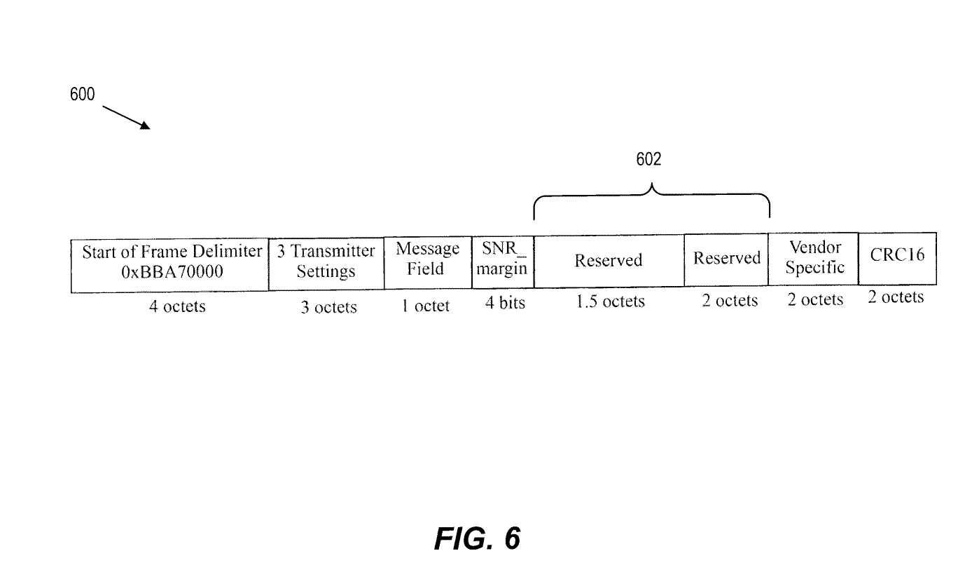

FIG. 6 illustrates an exemplary info-field 600 from the IEEE 802.3an standard, according to certain embodiments. One or more reserved bits 602 of the info-field 600 can be allocated to include the calculated SNR for the broadband test signals. The info-field 600 can also be used to transmit the signal characteristics of the broadband test signals. As discussed previously, the info-field is mapped to the PAM2 test signals, which is then transmitted to the switch 202 and/or remote access points 204 via the reply signal. Other info-field formats from the IEEE 802.3an standard can also be used transmitting the calculated SNR, such as the info-field transition counter format and the info-field coefficient exchange format. In addition, the SNR values can also be allocated to other bits of the info-field than the reserved bits.

Referring back to FIG. 3, at step S310, the processing circuitry of the switch 202 determines achievable data rates for the communication links in the communication system 200 based on the calculated SNRs at the switch 202 and the remote access points 204, which indicate an amount of crosstalk noise present at each end of the cables 206 as well as the overall signal strength. In addition, the data rate determinations are made as a function of signal operating frequency. For example, the achievable data rates for the communication links are based on achieving a minimum SNR of 23.9 dB at the switch 202 and/or the remote access points 204 that corresponds to a minimum block error rate (BER) performance of 10⁻¹² for the ETHERNET standard.

In one implementation, the processing circuitry of the switch 202 determines SNR values for the data rates at which the devices and/or cables 206 are capable of operating. For example, since the SNR calculation at step S306 is based on a broadband test signal having a bandwidth corresponding to the 10 Gbps data rate, the processing circuitry can also determine the SNR for the data rates that are less than or equal to 10 Gbps. For Cat5e cables, the data rates can be in a range from 1 Gigabit per second (Gbps) to 10 Gbps, including 2.5 and 5 Gbps. The processing circuitry determines that the switch and/or remote access points 204 are capable of operating at a particular data rate if the SNR associated with that data rate is greater than the minimum SNR of 23.9 dB. According to some aspects, the data rate capabilities determined for each of the cables 206 in the communication system 100 may not be equal. For the example where four ports on the switch 202 are connected to four remote access points 204, the processing circuitry of the switch 202 may determine that two of the cables 206 can achieve a 2.5 Gbps data rate and the other two cables 206 can achieve a 5 Gbps data rate while still maintaining the minimum SNR criteria.

Once the achievable data rates are determined for the cables 206 connecting the switch 202 and the remote access points 204, the processing circuitry writes the data rates to one or more current operational data rate bits allocated to a register of the switch 202 PHY, and the switch 202 communicates the achievable data rates to the remote access points 204. If the current operational data rates do not equal the data rates indicated by the data rate capability bits, the processing circuitry sets the override bit of the data rate capability bits to indicate that current operational data rates take precedence over the hardware capability data rates.

At step S312, the PHYs in the switch 202 and the remote access points 204 exit the test mode and resume to normal operations. The processing circuitry of the switch 202 may determine that the test mode can be exited when data rates have been determined for each of the cables 206 connecting the switch 202 to the remote access points. When the test mode is deactivated, the PHYs in the switch 202 communicate with the PHYs in the remote access points 204 to exit the test mode. According to certain embodiments, the PHYs in the switch 202 can communicate with the PHYs in the remote access points 204 to exit the test mode via a test mode deactivation signal that can include an info-field in the 10GBASE-T start-up procedure.

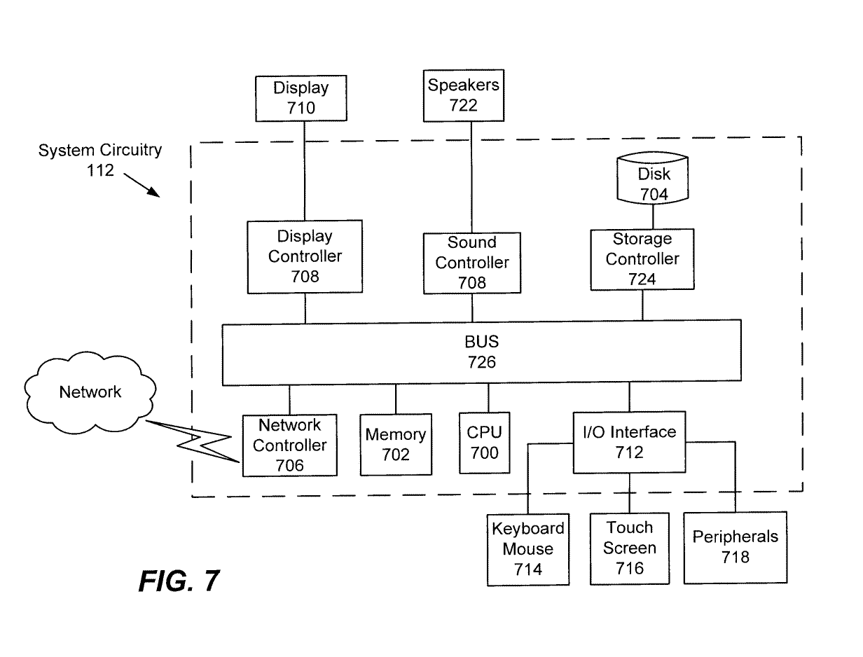

Next, a hardware description of the device circuitry 112 of the first device 102 according to exemplary embodiments is described with reference to FIG. 7. For example, the first device 102 may be the switch 202 in the communication system 200 described previously. The hardware description herein can also be applied to the device circuitry 120 of the second device 104, such as the remote access point 204 in the communication system 200. In FIG. 7, the device circuitry 112 includes a CPU 700 which includes processing circuitry to perform the processes described above/below. The process data and instructions may be stored in memory 702. These processes and instructions may also be stored on a storage medium disk 704 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device circuitry 112 communicates, such as a server or computer.

Further, the claimed advancements may be provided as a utility application, background daemon, or component of an operating system, or combination thereof, executing in conjunction with CPU 700 and an operating system such as Microsoft Windows 7, UNIX, Solaris, LINUX, Apple MAC-OS and other systems known to those skilled in the art.

The hardware elements in order to achieve the device circuitry 112 may be realized by various circuitry elements, known to those skilled in the art. For example, CPU 700 may be a Xenon or Core processor from Intel of America or an Opteron processor from AMD of America, or may be other processor types that would be recognized by one of ordinary skill in the art. Alternatively, the CPU 700 may be implemented on an FPGA, ASIC, PLD or using discrete logic circuits, as one of ordinary skill in the art would recognize. Further, CPU 400 may be implemented as multiple processors cooperatively working in parallel to perform the instructions of the inventive processes described above.

The device circuitry 112 in FIG. 4 also includes a network controller 706, such as an Intel Ethernet PRO network interface card from Intel Corporation of America, for interfacing with a network. As can be appreciated, the network can be a public network, such as the Internet, or a private network such as an LAN or WAN network, or any combination thereof and can also include PSTN or ISDN sub-networks. The network can also be wired, such as an Ethernet network, or can be wireless such as a cellular network including EDGE, 3G and 4G wireless cellular systems. The wireless network can also be WiFi, Bluetooth, or any other wireless form of communication that is known.

The device circuitry 112 further includes a display controller 708, such as a NVIDIA GeForce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710. General purpose I/O interface also connects to a variety of peripherals 718 including printers and scanners.

A sound controller 720 is also provided in the device circuitry 112, such as Sound Blaster X-Fi Titanium from Creative, to interface with speakers/microphone 722 thereby providing sounds and/or music.

The general purpose storage controller 724 connects the storage medium disk 704 with communication bus 726, which may be an ISA, EISA, VESA, PCI, or similar, for interconnecting all of the components of the device circuitry 112. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset.

The flowcharts or process diagram of FIG. 3 is representative of certain processes, functionality, and operations of embodiments discussed herein. Each block may represent one or a combination of steps or executions in a process. Alternatively or additionally, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as the CPU 700. The machine code may be converted from the source code, etc. Further, each block may represent, or be connected with, a circuit or a number of interconnected circuits to implement a certain logical function or process step.

Although the flowcharts or process diagram of FIG. 3 illustrates an order, it is understood that the order may differ from that which is depicted. For example, an order of execution of two or more blocks may be scrambled relative to the order shown. Also, two or more blocks shown in succession in FIG. 3 may be executed concurrently or with partial concurrence. Further, in some embodiments, one or more of the blocks shown in FIG. 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

1. A device comprising:
circuitry configured to
transmit a first test signal to another device via one or more communication links,
receive a second test signal transmitted from the another device via the one or more communication links,
determine a signal-to-noise ratio (SNR) at the device and the another device, and
determine data rates for the one or more communication links based on the SNR at the device and the another device.

2. The device of claim 1, wherein the circuitry is further configured to activate a test mode at the device and the another device by exchanging a test mode capability bit during an auto-negotiation sequence.

3. The device of claim 2, wherein the circuitry is further configured to determine an expiration time for the test mode.

4. The device of claim 1, wherein the circuitry is further configured to simultaneously transmit the first test signal and receive the second test signal.

5. The device of claim 4, wherein the circuitry is further configured to determine the crosstalk noise for the unshielded cable pairs having undefined crosstalk noise specifications.

6. The device of claim 4, wherein the unshielded cable pairs include Cat5e cables.

7. The device of claim 1, wherein the circuitry is further configured to perform one or more steps of a 10GBASE-T start-up sequence to transmit the first test signal.

8. The device of claim 7, wherein the circuitry is further configured to transmit the first test signal having a unique pseudo random bit sequence (PRBS).

9. The device of claim 8, wherein the circuitry is further configured to include one or more signal characteristics in an info-field of the first test signal.

10. The device of claim 7, wherein the circuitry is further configured to separate a noise portion from a signal portion of the second test signal based on a unique PRBS associated with the second test signal.

11. The device of claim 1, wherein the circuitry is further configured to determine the SNR at the device based on crosstalk noise and signal strength parameters of the second test signal.

12. The device of claim 1, wherein the circuitry is further configured to determine the SNR at the another device based on SNR values in an info-field of a reply signal.

13. The device of claim 11, wherein the circuitry is further configured to determine the data rates for the one or more communication links based on an operating frequency of the one or more communication links.

14. The device of claim 1, wherein the circuitry is further configured to assign the data rates for the one or more communication links to corresponding current operational data rate bits.

15. The device of claim 14, wherein the circuitry is further configured to set a data rate override bit when the current operational data rate bits are unequal to one or more hardware data rate capability bits.

16. The device of claim 1, wherein the circuitry is further configured to determine the data rates in a range from 1 Gbps to 10 Gbps for the one or more communication links.

17. The device of claim 1, wherein the circuitry is further configured to determine a test mode data rate based on predetermined test mode performance criteria.

18. The device of claim 1, wherein the circuitry is further configured to transmit a test mode deactivation signal to the another device.

19. A method comprising:
transmitting a first test signal from a device to a another device via one or more communication links;
receiving a second test signal transmitted from the another device via the one or more communication links;
determining a signal-to-noise ratio (SNR) at the device and the another device; and
determining data rates for the one or more communication links based on the SNR at the device and the another device.

20. A device comprising:
circuitry configured to
identify one or more aggressor signals on one or more cables of a Cat5e cable installation,
measure an effect of the one or more aggressor signals on noise present in one or more victim signals, and
determine a maximum data rate for the one or more cables to achieve predetermined noise and signal strength criteria.
